(19) United States
(12) Patent Application Publication
(10) Pub. No.: US 2023/0334279 A1
(43) Pub. Date: Oct. 19, 2023

(54) VEHICLE ACCESS CARD WITH AN INTEGRATED DISPLAY

(71) Applicant: Ford Global Technologies, LLC, Dearborn, MI (US)

(72) Inventors: Jochen Schubert, Farmington Hills, MI (US); Vivekanandh Elangovan, Canton, MI (US)

(73) Assignee: Ford Global Technologies, LLC, Dearborn, MI (US)

(21) Appl. No.: 17/659,109

(22) Filed: Apr. 13, 2022

(51) Int. Cl. G06K 19/077; G06K 19/07; G06Q 30/02; G06Q 10/00; B60R 25/24; G07C 9/29; G07C 9/22; G07C 9/00

(52) U.S. Cl. CPC G06K 19/07707; G06K 19/0723; G06Q 30/0267; G06Q 30/0207; G06Q 10/20; B60R 25/241; G07C 9/29; G07C 9/22; G07C 9/00309; B60R 2325/105; G07C 2009/00769; G07C 2209/04; G07C 2209/08

(57) ABSTRACT

This disclosure describes a vehicle access card with an integrated display. An example vehicle access card may include a radio-frequency identification (RFID) tag configured to provide a user access to a vehicle. The example vehicle access card may also include an electronic ink display configured to display information relating to the vehicle.

### BACKGROUND

Vehicle access cards, such as Radio Frequency Identification (RFID) key cards may be used to unlock a vehicle and to start the vehicle (and/or for any other purpose). However, vehicle access cards have typically only relied on static graphics printed on the plastic, such as the vehicle maker logo. These generic designs may make it difficult for a user with multiple vehicle access cards to quickly discern which card is paired to which vehicle (among other information).

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements, which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIGS. 1A-1G illustrate example vehicle access cards, in accordance with one or more embodiments of the disclosure.

FIG. 2 illustrates an example method, in accordance with one or more embodiments of the disclosure.

FIG. 3 illustrates an example of a system, in accordance with one or more embodiments of this disclosure.

FIG. 4 illustrates an example of a computing system, in accordance with one or more embodiments of this disclosure.

### DETAILED DESCRIPTION

This disclosure relates to, among other things, a vehicle access card (which may also be referred to here as a “key card,” “RFID card,” or the like) with an integrated display. Vehicle access cards, such as radio-frequency identification (RFID) key cards (for example, a near-field communication (NFC) key card and/or any other type of RFID key card) may be used to unlock a vehicle, start the vehicle, and/or provide access to any other functionality of the vehicle. The vehicle access card may operate as an active device, meaning the user may actively tap the card to an exterior RFID location of the vehicle to unlock the vehicle and also taps the card in an interior RFID location of the vehicle to start the vehicle. This is opposed to a passive device, where the vehicle may unlock and/or start due to the device's proximity to the vehicle. Vehicle access cards may be implemented as an alternative to traditional vehicle key fobs. In some cases, it may be desirable for a vehicle access card to be a primary credential that comes from the factory along with the vehicle.

Vehicle access cards using RFID technology often only comprise plastic cards including static graphics printed on the plastic, such as the original equipment manufacturer (OEM) logo. These types of key cards may provide limited (or no) information to the user. Given this, a user may lack information that may be important to the usage of the vehicle access card and/or the vehicle. As a first example, key cards can be paired with multiple vehicles, and the user may be unsure which vehicles can be used with a specific card. As a second example, a user may have multiple key cards and may not know which key card corresponds to a particular vehicle. As a third example, key cards may support complex tap-based gesture control systems for remote vehicle commands (for example, used to open the vehicle and/or use the vehicle), and the gestures may be difficult to memorize. In such cases, a user may be unaware if they are performing a gesture properly, which command was detected and sent to the vehicle, or the resulting vehicle status. As a fourth example, key cards may be programmed with limited vehicle permissions or time-bound access that is difficult to memorize (for example, one key card may be used to only unlock the trunk/rear hatch within a specified two hour time window, while another can be used to drive the vehicle up to 65 mph at any time of day). These types of information may be beneficial for the user to have when using one or more vehicle access cards.

Some vehicle fobs may include small liquid crystal displays (LCDs) or organic light-emitting diode (OLED) displays intended to share useful data and alerts with a user. However, these key fobs require far more power than may be available on an RFID card. An RFID card may often not include an integrated battery (for example, the RFID card may be powered by vehicle backscatter) or only a very small battery (for example, 225 mAh or any other value).

Additionally, while mobile applications and vehicle displays (for example, a human-machine interface (HMI) of the vehicle) may be used to convey these types of information, viewing this information using these types of methods may not be preferable or even possible for some users and/or vehicles. For example, many users do not wish to use mobile applications to constantly monitor vehicle status, do not carry fragile smartphones in harsh environments or job sites (or simply may not have a smartphone with them at all times), or may not have a vehicle equipped with complex and costly infotainment displays or connectivity functionality that allow for the presentation of such information.

To address these downsides, in one or more embodiments, an improved vehicle access card as described herein may include a low-power, flexible e-ink display. Integration of an e-ink display into a vehicle access card provides unique features in a smaller, cheaper device when compared to bulky, expensive key fobs with LCD or OLED screens. These e-ink displays are available in a variety of sizes that can cover large portions of the card, are thin enough to avoid adding significant bulk to the card, and are flexible enough to allow the display to bend and twist along with the plastic card while in a wallet, pocket, bag, etc. E-ink is also ideal for a card with little or no internal battery capacity as the displays draw very little power, if any, when displaying static information or images that do not need to change frequently.

The integrated e-ink display may present a number of different types of information to the user. As a first example, the display may present a customized image of the associated vehicle model or the model name, potentially unique to each trim level. For example, if the vehicle access card is currently programmed to allow a user access to a specific vehicle, an image of the vehicle model may be displayed on the e-ink display. The e-ink display may also present other information, such as text indicating the year, make, model, and trim of the vehicle. This image can change as the card is programmed to be usable on additional vehicles. Additionally, if the vehicle access card is programmed to allow access to multiple vehicles, the e-ink display may present images of each of the vehicles as well. For example, the images may be presented at the same time, or the e-ink display may cycle through the images of the different vehicles. The images of the different vehicles may also be presented based on any other conditions. For example, an image of the vehicle that was most recently accessed using the vehicle access card may be presented. The image may update to a different vehicle when the different vehicle is accessed.

As a second example, the display may present permissions granted to the user with respect to a particular vehicle. In some cases, a vehicle access card may be programmed to allow the user to unlock only certain portions of the vehicle. For example, a vehicle access card may be programmed to allow the user access to the interior of the vehicle through any of the doors but may prevent the user from accessing the trunk or the engine bay. The vehicle access card may also be programmed to allow the user to start the vehicle and may either provide full vehicle functionality to the user or may restrict certain vehicle functions. For example, based on the permissions provided to the user through the vehicle access card, the vehicle may be limited in terms of performance. As a specific use case, a parent may not desire for their child to have access to all of the horsepower available in a vehicle. In such cases, the vehicle access card used by the child may be programmed to only allow the user to use half of the available horsepower. This may also apply to any other performance parameters, such as maximum speed, etc. Any other functionality of the vehicle may also be limited, such as radio usage, seat adjustment capabilities, and/or any other types of functionalities of the vehicle.

As a third example, the display may present an indication of maintenance that may currently be required or may be required in the future for the vehicle. If vehicle service is needed (for example, if an oil change is required soon), the vehicle access card may obtain this information from the vehicle when the vehicle access card is proximate to the vehicle (for example, when the vehicle access card sends and receives signals to and from the vehicle to provide the user access to the vehicle and use of the vehicle. The vehicle access card may request this information from the vehicle and/or the vehicle may automatically provide such information to the vehicle access card. The vehicle access card may also be capable of receiving this information even when the vehicle access card is not proximate to the vehicle. For example, the vehicle access card may receive the information through long-range communication protocols, such as Wi-Fi, etc. The vehicle access card may also obtain this information from any other source, such as a remote server, or may store the information locally. Once the information is received, the vehicle access card may display the service alert to the user. Information regarding the maintenance can be displayed persistently on the vehicle access card as a reminder without requiring the user to access the vehicle, open an application, check their emails, etc. For example, the information may include a description of the type of maintenance, an amount of time until the maintenance is required, etc. The vehicle access card may also provide a discount code for the service at a nearby dealership. These discount codes transferred to the vehicle access card may be automatically obtained by the vehicle using its telematics connection and additional data, such as vehicle DTCs (diagnostic trouble codes) geographic location, dealerships preferred by the vehicle owner, service history of the vehicle, etc. Additional marketing opportunities may also leverage this vehicle access card to display recommendations for additional vehicle accessories or other services such as car washes.

As a fourth example, the display may present a date and time when the permissions granted by the vehicle access card are set to expire for a given vehicle. For example, a user may be provided a vehicle access card as a part of a rental service and the vehicle access card may be programmed to only provide the user access to the rental vehicle for the duration of the rental agreement.

As a fifth example, the display may present vehicle status information. For example, the display may present a fuel level, a battery charge, diagnostic information, such as diagnostic trouble codes, and/or any other information about the status of the vehicle. In some cases, the vehicle access card may obtain this information from the vehicle when the vehicle access card is proximate to the vehicle (for example, when the vehicle access card sends and receives signals to and from the vehicle to provide the user access to the vehicle and use of the vehicle. The vehicle access card may also be capable of receiving this information even when the vehicle access card is not proximate to the vehicle. For example, the vehicle access card may receive the information through long-range communication protocols, such as Wi-Fi, etc. The vehicle access card may also obtain this information from any other source, such as a remote server, or may store the information locally.

As a sixth example, the display may present a parking location of the vehicle associated with the vehicle access card. For example, the display may present the location as a dot on a map, an indication of a parking floor or zone, and/or in any other presentation format.

As a seventh example, the display may present instructions for available gesture commands if a tap-based gesture control system is available. If such a gesture control system is available, responsive to the performance of a gesture using the key card, a BLE transceiver or other RF radio system of the vehicle access card may be woken up, and an RKE command corresponding to the gesture may be sent to the vehicle. Different gestures (e.g., single, double, or triple taps; slowly repeated taps vs quick taps, etc.) may cause different commands to be sent by the access device. Moreover, such a system is expandable, and additional command triggers may be added through updating the mapping of gestures to RKE commands, whereas hardware changes are needed to add more physical buttons to the access device. Thus, the performance of the gesture may provide a configurable and power-saving command input method to the NFC key card. The display may also present instructions for available gesture commands or provide gesture coaching during a training mode (e.g. provide feedback to the user when testing out single, double, triple taps for different gestures).

With respect to the seventh example, the display may also present an indication of which RKE command was sent to the vehicle (for example, lock, unlock, remote start) and/or may also present a received status response from the vehicle (for example, vehicle locked, unlocked, climate system activated, etc.). This may allow the user to have information regarding the communications that are taking place between the vehicle access card and the vehicle to perform troubleshooting if required. For example, if the user taps the vehicle access card to the vehicle and the vehicle door does not unlock, the user may check the e-ink display to determine if the unlock command was sent and/or if the vehicle unlocked response was received. While several examples of types of information that may be displayed on the e-ink display have been mentioned herein, these examples are not intended to be limiting in any way. For example, any other types of information may also be presented as well.

Power consumption may be acceptable and viable for an access card with a battery with less than a few hundred mAh of capacity (and/or any other battery capacity). If the image on the display remains static, the screen can remain in a deep sleep state where it draws a very low average current of a few μA (and/or any other average current). In a deep sleep state, the display can show static information for several years. However, when refreshing the full image, flexible e-ink displays may utilize several mA, which may quickly drain a small battery. To overcome this limitation, these full image updates could be limited to when the vehicle access card is able to be powered from the vehicle reader's backscatter instead of the card's internal battery. When only a small portion of the image requires an update (for example, changing small icons, updating a portion of text or displayed value) less current is required and the internal battery can power these small pixel state updates.

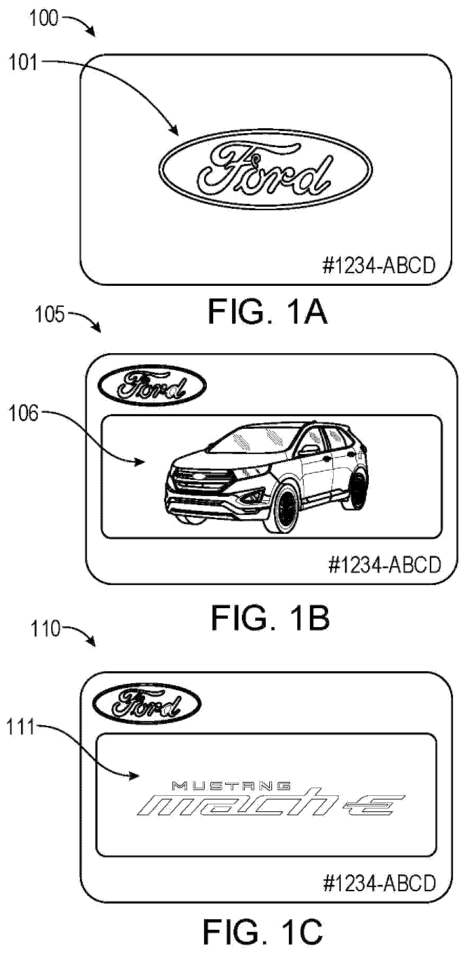

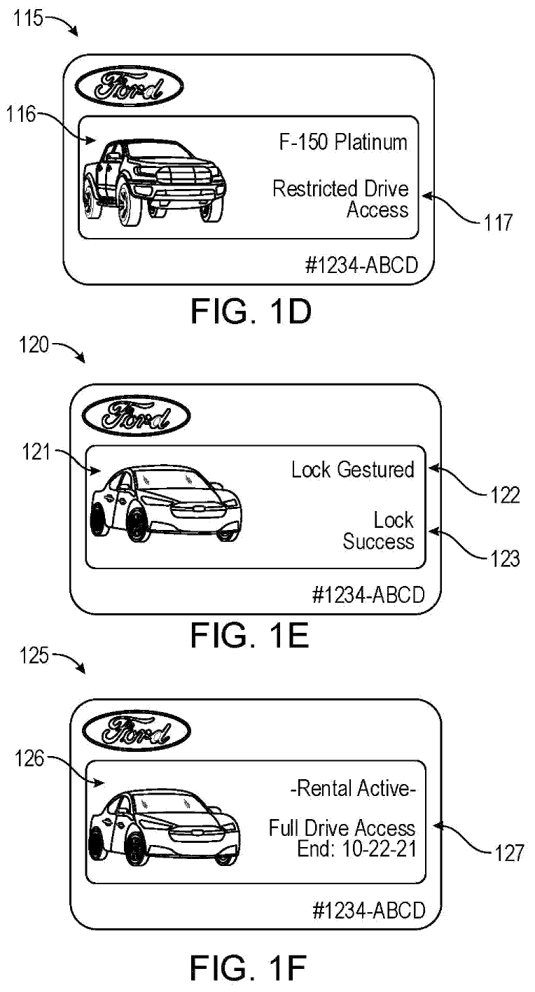

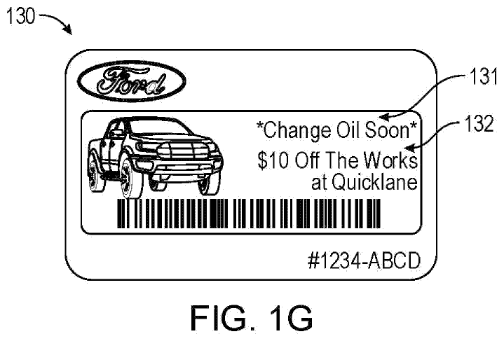

Turning to the figures, FIGS. 1A-1G illustrate example vehicle access cards, in accordance with one or more embodiments of the disclosure.

FIG. 1A illustrates a first example vehicle access card 100. As shown in the figure, the first example vehicle access card 100 may be a standard vehicle access card that may only include static graphics 101 printed on the plastic, such as an OEM logo. Such a vehicle access card 100 may make it difficult for a user with multiple vehicle access cards to quickly discern which card is paired to which vehicle (if multiple vehicles and/or multiple vehicle access cards are involved). The vehicle access card 100 may also lack other types of information that may be beneficial to the user as described herein.

FIG. 1B illustrates a second example vehicle access card 105. The second vehicle access card 105 may illustrate another example of a type of information that may be presented to a user through the e-ink display 106. For example, the e-ink display 106 shows an image of the last vehicle that was paired with the third example vehicle access card 105. A vehicle access card being “paired” with a vehicle may refer to the vehicle access card being configured to provide a user access to the vehicle and functionality of the vehicle. In one or more embodiments, the user may customize the manner in which the last-paired vehicle is indicated through the e-ink display 106. For example, the user may indicate that a vehicle logo should be displayed, that text should be displayed, that an image of the vehicle should be displayed, and/or any other format. As another example of a manner in which the user can customize the display, the third example vehicle access card 110 of FIG. 1C shows an e-ink display 111 presenting a logo associated with the vehicle rather than an image of the vehicle.

FIG. 1D illustrates a fourth example vehicle access card 115. The fourth vehicle access card 115 may illustrate another example of a type of information that may be presented to a user through the e-ink display 116. For example, the e-ink display 116 displayed the last-paired vehicle as well as additional information relating to the vehicle and the pairing. In one or more embodiments, the additional information may include permissions information 117 providing an indication of permissions granted to the user with respect to a particular vehicle. For example, the vehicle access card 115 may be programmed to allow the user to unlock only certain portions of the vehicle, such as any of the doors, the trunk, the engine bay, etc. The vehicle access card 115 may also be programmed to allow the user to start the vehicle and may either provide full vehicle functionality to the user or may restrict certain vehicle functions as described above.

FIG. 1E illustrates a fifth example vehicle access card 120. The fifth example vehicle access card 120 may illustrate another example of a type of information that may be presented to a user through the e-ink display 121. For example, the e-ink display 121 shows a gesture status 122 and command status 123. If a gesture control system is available, responsive to the performance of a gesture using the key card, a BLE transceiver or other RF radio system of the vehicle access card may be woken up, and an RKE command corresponding to the gesture may be sent to the vehicle. Different gestures (e.g., single, double, or triple taps; slowly repeated taps vs quick taps, etc.) may cause different commands to be sent by the access device. The e-ink display 121 may also present instructions for available gesture commands or provide gesture coaching during a training mode (e.g. provide feedback to the user when testing out single, double, triple taps for different gestures). The e-ink display 121 may also present an indication of which RKE command was sent to the vehicle (for example, lock, unlock, remote start) and/or may also present a received a status response from the vehicle (for example, vehicle locked, unlocked, climate system activated, etc.).

FIG. 1F illustrates a sixth example vehicle access card 125. The sixth example vehicle access card 125 may illustrate another example of a type of information that may be presented to a user through the e-ink display 126. For example, the e-ink display 126 may present date and/or time information 127 indicating when the permissions granted by the vehicle access card are set to expire for a given vehicle. For example, a user may be provided a vehicle access card 125 as a part of a rental service and the vehicle access card 125 may be programmed to only provide the user access to the rental vehicle for the duration of the rental agreement.

FIG. 1G illustrates a seventh example vehicle access card 130. The seventh example vehicle access card 130 may illustrate another example of a type of information that may be presented to a user through the e-ink display 131. For example, the e-ink display 131 may present an indication of maintenance that may currently be required or may be required in the future for the vehicle, as described above. If vehicle service is needed (for example, if an oil change is required soon), the vehicle access card may obtain this information from the vehicle when the vehicle access card is proximate to the vehicle. Additional information may also be presented as well, such as an advertisement 132. The advertisement 132 may be an advertisement for a service that may perform the required vehicle maintenance. These displayed advertisements may be transferred to the vehicle access card by the vehicle during a near field communications tap. The vehicle may automatically obtain these advertisements from a server using its telematics connection and additional data, such as vehicle DTCs (diagnostic trouble codes) geographic location, dealerships preferred by the vehicle owner, service history of the vehicle, etc. Additional marketing opportunities may also leverage this vehicle access card to display recommendations for additional vehicle accessories or other services such as car washes, maintenance discounts, etc.

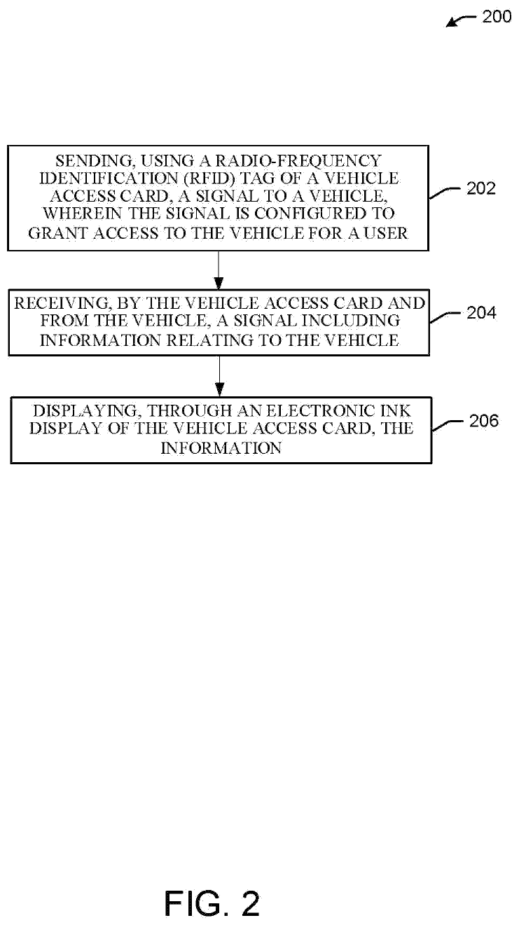

FIG. 2 illustrates an example method 200, in accordance with one or more embodiments of this disclosure. Block 202 of the method 200 may include sending, using a radio-frequency identification (RFID) tag of a vehicle access card (for example, access device 105, any of the vehicle access cards illustrated in FIGS. 1A-1F, and/or any other vehicle access card), a signal to a vehicle (for example, vehicle 102), wherein the signal is configured to grant access to the vehicle for a user. Block 204 of the method may include receiving, by the vehicle access card and from the vehicle, information relating to the vehicle. Block 206 of the method 200 may include displaying, through an electronic ink display of the vehicle access card, the information.

In one or more embodiments, the information comprises an image of the vehicle. In one or more embodiments, the information comprises an indication of an access level provided by the vehicle access card for the vehicle, wherein the access level determines a usage restriction for the vehicle when accessed using the vehicle access card. In one or more embodiments, the information comprises a date and time after which the vehicle access card is no longer configured to provide access to the vehicle. In one or more embodiments, the information comprises a vehicle access card command status and a vehicle response status, wherein the vehicle response status is received from the vehicle. In one or more embodiments, the information comprises an indication of a required maintenance for the vehicle. The information may also include any other types of information described herein or otherwise. In one or more embodiments, the RFID tag is further configured to provide the user limited access to the vehicle.

While the method 200 of FIGS. 1-2 may have been described above as being performed by a user device, or more specifically, by one or more program module(s), applications, or the like executing on a device. It should be appreciated, however, that the method 200 may be performed, at least in part, in a distributed manner by one or more other devices, or more specifically, by one or more program module(s), applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the method 200 may be described in the context of the illustrative devices, it should be appreciated that such operations may be implemented in connection with numerous other device configurations.

The method 200 may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIG. 2 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

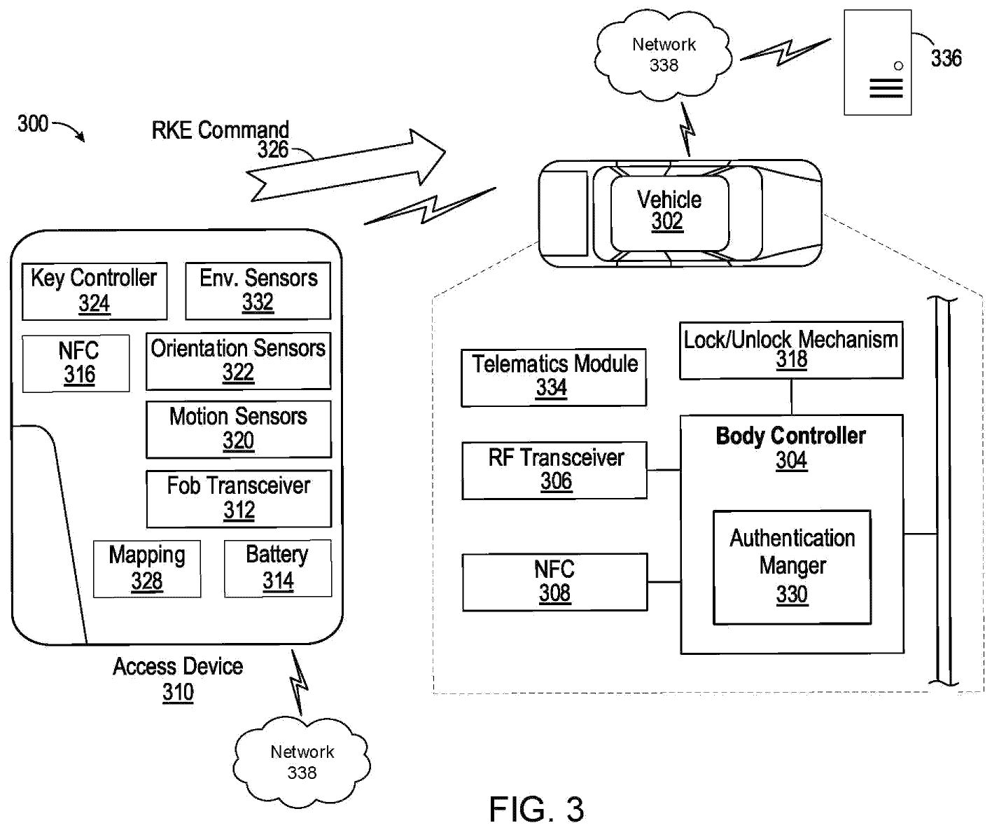

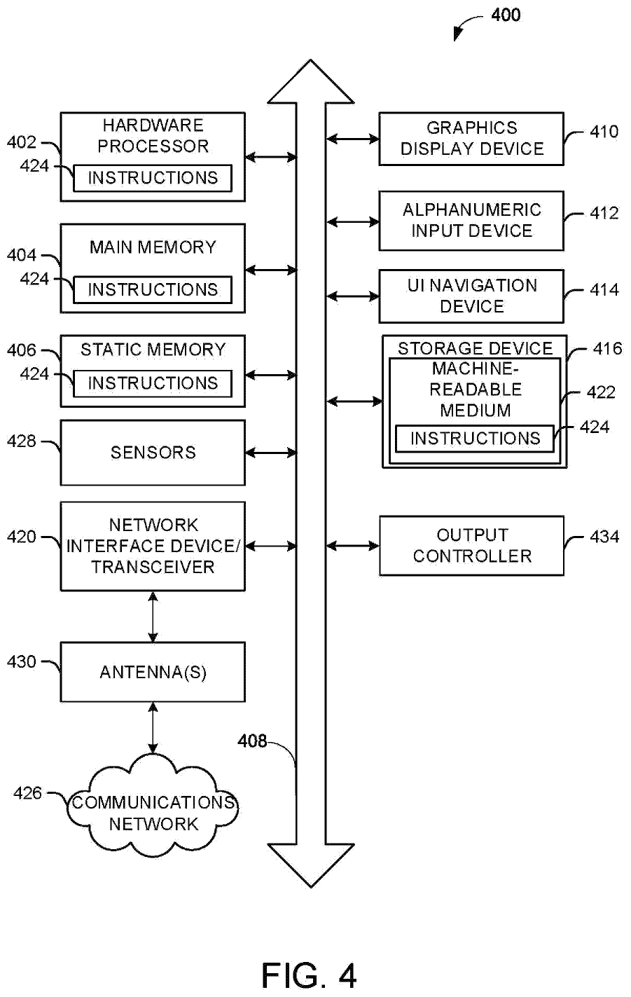

FIG. 3 illustrates an example keyless entry system 300 for a vehicle 302 implementing power-saving gesture-based command triggers. The vehicle 302 may include a body controller 304 in communication with a radio frequency (RF) transceiver 306, NFC sensors 308, and a lock/unlock mechanism 318. An access device 310 (which may be the same as the vehicle access card, key card, or the like as described herein) may be powered by a battery 314. The access device 310 may be in communication with the RF transceiver 306 via a transceiver 312 (e.g., BLE, UHF, etc.). The access device 310 may also be in communication with the NFC sensors 308 using NFC 316 functionality of the access device 310. As shown in FIG. 3, the access device 310 may be an NFC card. However, it should be noted that in other examples the access device 310 may be other types of device, such as a key fob (e.g., a fob without any buttons) a smart device such as watch, a mobile phone, or any other portable device configured as described herein. Additionally, any of the elements described with respect to system 300 may include elements of machine 400 described with respect to FIG. 4. That is, as illustrated in the figure, these elements of the system 300 may include one or more processor(s) and memory, as well as at least any other elements described as being included in the machine 400. That is, although the figure may only depict a particular element of system 300 as having one or more processors, memory, and one or more modules, this may not be intended to be limiting in any way.

The NFC sensors 308 of the vehicle 302 may include one or more sensors on the vehicle 302 exterior. These NFC sensors 308 may be used in conjunction with the access device 310 to request unlock or lock the vehicle 302 using NFC. Additionally, or alternately, the NFC sensors 308 may further include NFC sensors 308 within the vehicle 302 which may be used in conjunction with the access device 310 to request or authorize start of the vehicle 302.

A lock/unlock mechanism 318 may be operably coupled to the controller 304. For instance, the controller 304 may utilize the lock/unlock mechanism 318 to lock the doors of the vehicle 302 in response to receipt of a lock command from the access device 310, and to unlock the doors of the vehicle 302 in response receipt of an unlock command from the access device 310. In one example, the controller 304 may control the lock/unlock mechanism 318 to unlock the doors responsive to receipt of a signal from the exterior NFC sensors 308 indicative of the presence of the NFC 316 functionality of the access device 310. In another example, the controller 304 may be configured to control the lock/unlock mechanism 318 to unlock/lock doors of the vehicle 302 in response to RKE commands 326 transmitted by the access device 310.

The access device 310 may include one or more motion sensors 320 to allow for the user to input gestures by way of the access device 310. In an example, the motion sensors 320 may include one or more accelerometers, such as a three-axis linear accelerometer. The motion sensors 320 may be used to allow the access device 310 to detect gestures of the user performed to the access device 310. For instance, the motion sensors 320 may be used to provide signals that indicate sudden changes in g-forces when the user taps the access device 310 with a finger or bumps the whole card against a hand or other object. The motion sensors 320 may be placed in various physical locations along or within the access device 310, such that gestures can be uniquely detected in or more distinct regions of the device (e.g., one of four quadrants when viewing the device in a two-dimensional plane). As one possibility, a series of motion sensors 320 may be placed in a line along the length of the access device 310, or a grid of motion sensors 320 may be placed along a face of the access device 310. Differences in reading from the different motion sensors 320 may be used to localize the tap locations. In an example, a first reading from a first motion sensor 320 followed in time by readings from other motion sensors 320 of lesser magnitude may locate the tap closer to the first motion sensor 320.

The access device 310 may further include one or more orientation sensors 322. These orientation sensors 322 may include, as some examples, one or more gravity sensors and/or gyroscopes. The orientation sensors 322 may be used to detect the orientation of the access device 310, such as right side up or right side down. The orientation sensors 322 may also be used to detect intentional orientation changes of the access device 310 (e.g., flip actions, rotate actions, etc.) which can be used to trigger different actions or to put the access device 310 into different states. This orientation data may, in some examples, be combined with the tap detection as an approach to distinguish different types of commands.

The changes in g-force detected by the motion sensors 320 and/or changes in orientation detected by the orientation sensors 322 may be provided to a key controller 324 of the access device 310. The key controller 324 may receive the signals and use the signals to determine whether the user intended to send a certain RKE command 326 to the vehicle 302. If so, the key controller 324 may wake up the fob transceiver 312 (e.g., a BLE chip) and use the fob transceiver 312 to send the requested RKE command 326.

The access device 310 may maintain a command mapping 328 defining a mapping of user inputs to RKE commands 326. A command mapping 328 may be used by the key controller 324 to identify the command that was input. Different gestures based on the detected actions, such as single tap, double tap, triple tap, flip, rotation, etc., may be used to signify different RKE commands 326. A unique pattern of taps and pauses may also be detectable to trigger functions (e.g., double tap—pause—double tap for trunk release). These patterns may be stored to the command mapping 328 in association with the corresponding RKE commands.

In many examples, a default command mapping 328 may be installed to the access device 310 (e.g., from the factory). In some examples, new command mapping 328 may be deployed to the access device 310 via updated software for the access device 310. It some examples, the command mapping 328 may also be user-configurable. For instance, user-configured mappings may be provided over NFC from the vehicle 302, from a mobile device, or from another NFC device to the access device 310. The user may utilize an application on the vehicle 302, mobile device, etc. to configure which commands are mapped to which specific detected gesture.

The controller 304 may include an authentication manager 330. The authentication manager 330 may utilize the NFC 308 functionality of the vehicle 302 to sense the NFC 316 functionality of the access device 310 within the vehicle 302 cabin, which may cause the authentication manager 330 of the body controller 304 to allow the user to start the engine of the vehicle 302. The authentication manager 330 may also authenticate the requested RKE command 326 transmitted by the fob transceiver 312 to allow the user to start the engine of the vehicle 302.

In some examples, the access device 310 may also include environmental sensors 332 configured to provide additional contextual information to the key controller 324. This contextual information may be used by the access device 310 to differentiate between actual user requests for RKE commands 326 vs. transportation or jostling of the access device 310. In an example, the environmental sensors 332 may include proximity sensors, light sensors, flex sensors, and/or force sensitive resistors embedded into the access device 310. The key controller 324 may utilize signals from the environmental sensors 332 to determine whether to activate fob transceiver 312 and provide an RKE command 326 based on input from the motion sensors 320 and/or orientation sensors 322, or to ignore the input and not activate the fob transceiver 312. For instance, the key controller 324 may determine the access device 310 is located in a bag or pocket based on the signals from the environmental sensors 332 indicating that the access device 310 is in the dark, in close proximity to another object (e.g., indicative of being in a bag with other objects), and/or a slight bend in the access device 310 is detected (e.g., indicative of a card being in a wallet). If so, then events from the motion sensors 320 and/or orientation sensors 322 may be determined to be extraneous and be ignored.

The access device 310 may default to operation in an idle mode in which the fob transceiver 312 is not powered by the battery 314 but the motion sensors 320, orientation sensors 322, and/or environmental sensors 332 are powered. This may be done to minimize the battery 314 drain of the access device 310, as the fob transceiver 312 may be relatively power intensive to operate compared to the other components of the access device 310. Sudden changes in linear motion or orientation that indicate valid RKE commands 326 may be used by the key controller 324 to wake up the access device 310 into a transmit mode in which the fob transceiver 312 is powered. When the access device 310 is idle but the signals from the environmental sensors 332 indicate transport of the access device 310 but not command entry, the access device 310 refrains from waking up the fob transceiver 312, thereby conserving battery 314 power.

In one or more embodiments, the vehicle 302 may also include a telematics module 334. Additionally, the system may include a server 336. The server 336 may share advertisements and discount codes with the vehicle 302 that may be transferred to the access card. The server 336 may also store any other information described herein or otherwise that may be provided to the vehicle 302 and/or directly to the access device 310.

In one or more embodiments, any of the elements of the system 300 (for example, vehicle 302, access device 310, server 336, and/or any other element described with respect to FIG. 3 or otherwise) may be configured to communicate via a communications network 338. The communications network 338 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, the communications network 338 may have any suitable communication range associated therewith and may include, for example, global networks (e.g., the Internet), metropolitan area networks (MANs), wide area networks (WANs), local area networks (LANs), or personal area networks (PANs). In addition, communications network 338 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

FIG. 4 depicts a block diagram of an example machine 400 upon which any of one or more techniques (e.g., methods) may be performed, in accordance with one or more example embodiments of the present disclosure. In other embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environments. The machine 400 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a graphics display device 410, an alphanumeric input device 412 (e.g., a keyboard), and a user interface (UI) navigation device 414 (e.g., a mouse). In an example, the graphics display device 410, alphanumeric input device 412, and UI navigation device 414 may be a touch screen display. The machine 400 may additionally include a storage device (i.e., drive unit) 416, a network interface device/transceiver 420 coupled to antenna(s) 430, and one or more sensors 428, such as a global positioning system (GPS) sensor, a compass, an accelerometer, or other sensor. The machine 400 may include an output controller 434, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within the static memory 406, or within the hardware processor 402 during execution thereof by the machine 400. In an example, one or any combination of the hardware processor 402, the main memory 404, the static memory 406, or the storage device 416 may constitute machine-readable media.

While the machine-readable medium 422 is illustrated as a single medium, the term “machine-readable medium” may include a single medium or multiple media (e.g., a centralized or distributed database, and/or associated caches and servers) configured to store the one or more instructions 424.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 400 and that cause the machine 400 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device/transceiver 420 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 420 may include one or more physical jacks (e.g., Ethernet, coaxial, or phone jacks) or one or more antennas to connect to the communications network 426. In an example, the network interface device/transceiver 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 400 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, certain systems and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

1. A vehicle access card comprising:
a radio-frequency identification (RFID) tag configured to provide a user access to a vehicle; and
an electronic ink display, wherein the vehicle access card is configured to:
send a signal to the vehicle, wherein the signal is configured to grant access to the vehicle for a user;
receive, by the vehicle access card and from the vehicle, information including an indication of an access level provided by the vehicle access card for the vehicle, wherein the access level determines a usage restriction for the vehicle when accessed using the vehicle access card and at least one of a date and time after which the vehicle access card is no longer configured to provide access to the vehicle; and
display, on the electronic ink display, the information relating to the vehicle.

2. The vehicle access card of claim 1, wherein the information comprises an image of the vehicle.

3-4. (canceled)

5. The vehicle access card of claim 1, wherein the information comprises a vehicle access card command status and a vehicle response status.

6. The vehicle access card of claim 1, wherein the information comprises at least one of: an indication of a required maintenance for the vehicle, an advertisement for an additional vehicle accessory or service, and/or a discount code for a vehicle maintenance.

7. The vehicle access card of claim 1, wherein the RFID tag is further configured to provide the user limited access to the vehicle.

8. A method comprising:
sending, using a radio-frequency identification (RFID) tag of a vehicle access card, a signal to a vehicle, wherein the signal is configured to grant access to the vehicle for a user;
receiving, by the vehicle access card and from the vehicle, information including an indication of an access level provided by the vehicle access card for the vehicle, wherein the access level determines a usage restriction for the vehicle when accessed using the vehicle access card and at least one of a date and time after which the vehicle access card is no longer configured to provide access to the vehicle; and
displaying, through an electronic ink display of the vehicle access card, the information.

9. The method of claim 8, wherein the information comprises an image of the vehicle.

10-11. (canceled)

12. The method of claim 8, wherein the information comprises a vehicle access card command status and a vehicle response status, wherein the vehicle response status is received from the vehicle.

13. The method of claim 8, wherein the information comprises at least one of: an indication of a required maintenance for the vehicle, an advertisement for an additional vehicle accessory or service, and/or a discount code for a vehicle maintenance.

14. The method of claim 8, wherein the RFID tag is further configured to provide the user limited access to the vehicle.

15-20. (canceled)

21. A system comprising:
a vehicle; and
a vehicle access card comprising:
a radio-frequency identification (RFID) tag configured to provide a user access to a vehicle; and
an electronic ink display configured to:
send a signal to the vehicle, wherein the signal is configured to grant access to the vehicle for a user;
receive, by the vehicle access card and from the vehicle, information including an indication of an access level provided by the vehicle access card for the vehicle, wherein the access level determines a usage restriction for the vehicle when accessed using the vehicle access card and at least one of a date and time after which the vehicle access card is no longer configured to provide access to the vehicle; and
display, on the electronic ink display, the information relating to the vehicle.

22. The system of claim 21, wherein the information comprises an image of the vehicle.

23. The system of claim 21, wherein the information comprises a vehicle access card command status and a vehicle response status, wherein the vehicle response status is received from the vehicle.

24. The system of claim 21, wherein the information comprises at least one of: an indication of a required maintenance for the vehicle, an advertisement for an additional vehicle accessory or service, and/or a discount code for a vehicle maintenance.
